(19) United States
(12) Patent Application Publication
(10) Pub. No.: US 2017/0151714 A1
(43) Pub. Date: Jun. 1, 2017

(54) Method of manufacturing extruded objects to increase production speed

(71) Applicant: Mike MCGEE, Amsterdam (NL)

(72) Inventor: Mike MCGEE, Amsterdam (NL)

(21) Appl. No.: 15/335,468

(22) Filed: Oct. 27, 2016

(30) Foreign Application Priority Data
Nov. 26, 2015 (NL) 1041597

(51) Int. Cl. B29C 67/00; B33Y 30/00; B33Y 50/02; B33Y 10/00

(52) U.S. Cl. CPC B29C 67/0055; B29C 67/0085; B29C 67/0088; B33Y 10/00; B33Y 30/00; B33Y 50/02

(57) ABSTRACT

A 3D printing apparatus, wherein the apparatus is configured to use a build material to form a peripheral wall in a plurality of layers, the combined plurality of layers having a first height, and to form an infill section within the peripheral wall, wherein said infill section is formed comprising a single layer and having a second height equal to the first height of the peripheral wall.

This application claims priority to NL patent application NL1041597 filed on 26 Nov. 2015 titled ‘Method for optimized manufacturing’. Application NL1041597 is hereby incorporated by reference.

### FIELD OF THE INVENTION

The present invention concerns a 3D printing apparatus; a system incorporating a 3D printing apparatus; a method of producing a 3D product; as well as products obtainable by such a method; and 3D printed products.

### BACKGROUND

In an additive manufacturing three-dimensional systems hereby referred to as 3D printing, an object can be formed from a digital model by laying down or forming successive layers of a material that accumulate to provide the desired object.

The term 3D printer may refer to any of the following technologies, SLA (stereo lithography apparatus) using a curable resin and a light source, SLS (selective laser sintering) using a powder which is bonded by a heat source which is usually a laser, FDM (fused deposition modelling) using bonded droplets of material to form an object, FFM (fused filament manufacturing) using an extruded material usually a thermoplastic, or LOM (laminated object modelling) using slices of material which is sometimes paper bonded together. The term also covers new developments such as apparatus which deposit a paste like substance such as concrete, cement or edible material such as chocolate or pancake mixture to form a multi layered 3D object. Apparatus that deposit liquids and gel like substances layer by layer to produce 3D products with genetic material therein are also covered by the term 3D printer. 3D printers may also use metal as a build material by which successive layers of metal are deposited usually using a welding type apparatus to bond small welds one on top of the other.

Certain manufacturing techniques render each layer as a single, continuous path of a material, typically completing a layer of the object in an x-y plane and then moving to a next z position (or height) for each subsequent layer. The path height and width are usually specified by the user at the time of preparing the 3D object for printing. The required path height and width are entered into a program typically known as slicing software and the software generates a set of instructions which direct the printer where and how to form each layer or slice of material. A layer is completed using multiple paths of extruded material which combine to form each layer.

One of the biggest drawbacks of 3D printing is that the objects can take several days to produce when the part is large and complex. This is because the 3D printed object usually contains a printed outer wall portion and a printed inner portion that can be solid or partially solid to give the object rigidity. The term outer wall portion refers to the visible outer layer, peripheral wall, outer wall or shell of the printed object. The term inner portion refers to the inner layer, infill section, inner core or part of the inside of the printed object.

A partially solid inner core or infill section can be composed of any geometric or random pattern, honeycomb or rectilinear infill is a typically used example, to fill the object and add material to support and add strength to the outer wall. Infill is a commonly used term in the 3D printing community.

One way to reduce the printing time is to increase the individual layer height of the print so that the sliced file and the object produced consist of fewer layers but of a greater layer height thickness. This way a finished printed model takes fewer layers to reach the top of the completed object. This method has the effect of reducing the quality of detail on the outside of the printed component as the detail quality is directly related to the thickness of each layer. For example, at 0.1 mm layer height, a 10 cm printed part would take 100 layers to print and details of up to 0.1 mm would be visible on the outside of the printed component. The same printed part would take about half the time and 50 layers to print at 0.2 mm layer height but the detail level on the outside of the printed component would also be halved to show details up to 0.2 mm.

Another technique sometimes referred to as ‘variable layer thickness’ is to combine layer height thickness so that at different Z heights of the printed part the thickness can be changed, for example a lower portion or lower Z height of the part that has important features can be printed using a thin layer height thus maintaining high print resolution then once a set Z height has been reached which is higher than the important features a thicker layer height may be used to produce the printed layers. This method still has the drawback that the printer is still building the object one complete layer at a time in the X-Y axis at a set layer height. In this application the thicker layer is adjacent to a thinner layer but the layers are above or below each other, for the purpose of this application and to distance this application from the known art the term adjacent will be used to refer to layers or extruded paths that are adjacent in the X-Y direction and occupy the same Z height or occupy a similar layer distance from the build plate within the printed object.

Some new printers reduce the printing time by adding multiple printing nozzles to the print head. A smaller diameter nozzle is used to produce the outer wall portion of the printed part and a larger diameter nozzle extrudes the inner portion of the printed model. The larger diameter nozzle is able to have a higher throughput of melted plastic when compared to the narrower nozzle and the larger diameter nozzle is therefore able to move faster whilst printing the inner portion of the part than when using a single smaller diameter nozzle. Whilst this does allow faster printing of 3D parts it still takes a considerable amount of time to produce a large complex part because the printer is still building the object one complete layer at a time in the X-Y axis at a set layer height.

Another method which has been used to reduce build time is to remove as much weight as possible from the 3D printers moving print head and therefore allow faster movement of the print head. One common method is known as the ‘Bowden’ method where a motor mechanically pushes filament into a tube known as a ‘Bowden Tube’ which directs the build material from the extrusion motor to the extrusion nozzle whilst keeping the weight of the extrusion motor away from the moving print head. The only weight on the moving print head is the nozzle and the lightweight ‘Bowden tube’. This results in a slightly lower build time.

To further increase speed there has been the development of algorithms which reduce the speed of the print head at the very end of high speed moves to absorb the inertial forces of the print head and allow even faster movements of the print head. The benefits of this however equate to only a small percentage of build time.

There thus remains a desire in the art for fast yet accurate 3D object manufacturing. The present invention concerns such desire.

### BRIEF SUMMARY OF THE INVENTION

In accordance with one aspect of the present invention there is provided a method of producing a 3D product, comprising the steps of:
i) printing an outer wall portion from an extruded build material to a specified dimension in a plurality of individual layers stacked one above the other, the plurality of individual layers having a predetermined height, and
ii) printing an inner portion adjacent to the peripheral wall or outer layer from an extruded, poured, dispensed or sprayed build material, wherein said inner section is formed using an individual layer thickness greater than the layer height thickness of the individual layers of outer wall portion.

The inner portion could therefore be poured or sprayed into the outer wall portion as a liquid or foam to complete the entire object or a build portion.

An outer wall portion of a 3D-printed object can be formed by printing a plurality of generally thin layers stacked one above the other, which layers accumulate forming the outer wall portion. The outer wall portion can be printed at a relatively high finish quality because each layer is generally thin and its form well controlled as it is printed. The high quality finish of the outer wall portion may be important in providing accurate shape, surface texture, surface properties and characteristics, and/or appearance to the 3D-printed object. An inner portion of the 3D-printed object is formed in layers having a layer height greater than that of the outer wall portion, but it comprises fewer accumulated layers than the outer wall portion. At least one of the layers in the inner portion is thicker than at least one of the layers in the outer wall portion. The inner portion could be extruded, poured in as a liquid or dispensed as a foam into the printed portion once the outer wall portion was in place to contain the inner portion. In this way the inner portion can be formed relatively quickly. The inner portion build material could have similar mechanical properties to the outer wall portion build material or the two materials could share different mechanical properties. The invention thus provides a 3D-printing method that is not only speedy but also provides a 3D-printed objection with a high quality finish to its outer wall portion.

### DESCRIPTION OF THE DRAWINGS

FIG. 1 shows four consecutive cross sections of a 3D printed object manufactured using the standard method of forming 3D objects.

FIG. 2 shows four consecutive cross sections of a 3D printed object manufactured using the new method of forming 3D objects in line with the current invention.

FIG. 3 shows a cross sectional side view of a 3D printed object printed using the standard method of forming 3D objects.

FIG. 4 shows a cross sectional side view of a 3D printed object printed using the current claimed invention as a method of forming 3D objects.

FIG. 5 shows a cross sectional side view of a 3D printed object printed using the current claimed invention as a method of forming 3D objects.

### DETAILED DESCRIPTION OF THE DRAWINGS

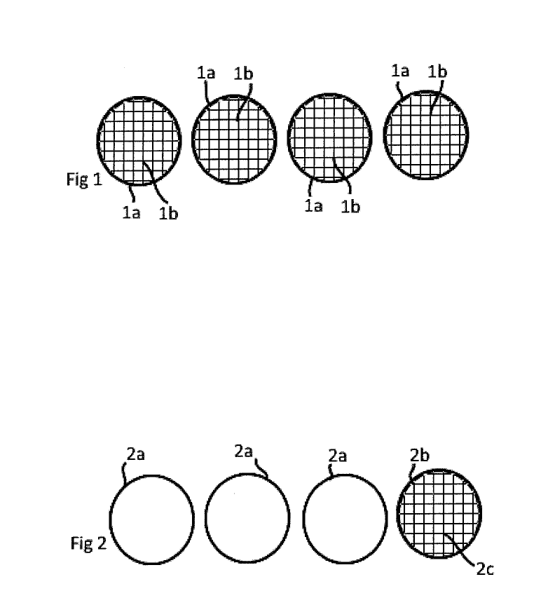

FIG. 1 shows four consecutive cross sections of a 3D printed object manufactured using the standard method of forming 3D objects. The shown object may be a part or portion of a larger 3D-printed object (not shown) Figure (1a) shows the outer wall portion of each layer and (1b) shows the inner portion or tool path followed to produce each layer. As can be seen from the figures each layer requires the apparatus to follow the entire path of both the outer wall portion (1a) and the inner portion (1b).

FIG. 2 shows four consecutive cross sections of a 3D printed object manufactured using showing the new method of forming 3D objects in line with the current invention. (2a) and (2b) shows the outer wall portion of each layer (2c) shows the inner portion which will be laid down or printed once a specified number of outer wall portion layers have been formed. In the current invention multiple layers of outer wall portion layers (2a) can be produced and the inner portion (2c) can be produced in one layer once a specified height is reached to complete the build portion.

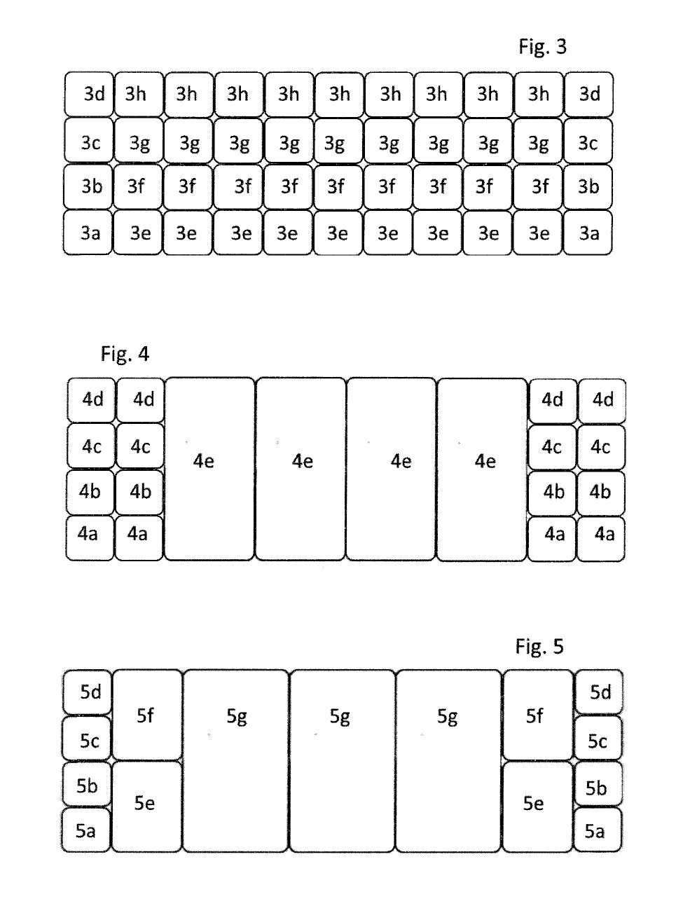

FIG. 3 shows a cross sectional side view of a 3D printed object printed using the standard method of forming 3D objects where the outer wall portion comprising of multiple layers (3a, 3b, 3c, 3d) is shown next to the inner portion comprising of the same amount of layers (3e, 3f, 3g, 3h) made up of multiple extruded paths of build material.

FIG. 4 shows a cross sectional side view of a 3D printed object printed using the current claimed invention as a method of forming 3D objects where the outer wall portion comprising of multiple layers (4a, 4b, 4c, 4d) each layer made up of multiple extruded paths or tool paths to produce each layer of build material is shown next to the inner portion (4e) made up of fewer extruded paths of build material.

FIG. 5 shows a cross sectional side view of a 3D printed object printed using the current claimed invention as a method of forming 3D objects where the outer wall portion comprising of multiple layers (5a, 5b, 5c, 5d) is shown next to the inner portion (5e, 5f, 5g).

### SUMMARY OF THE INVENTION

According to one aspect of the invention a 3D printing apparatus is configured to print several layers of outer wall portion build material such as an extruded plastic which are printed or laid down one on top of the next to produce a first height of outer wall portion. Once outer wall portion has been completed a second build material is used to form the inner portion. The inner portion is printed or formed at a thicker layer height than that used in the outer wall portion. The second build material could comprise a curable resin build material. This completes the build portion. The process can be repeated until the object height is completed. The inner portion could be laid down, printed or formed in a single layer filling the entire 3D object. This way, a structure able to support a higher stresses and loads than that the first build material alone could be produced by one 3d printing machine. For example, plastic components with resin reinforced support sections could be formed.

According to a one aspect of the invention a 3D printing apparatus is configured to print a material such as but not limited to concrete or plastic. The apparatus could be used to manufacture an outer wall portion of a printed object, once a set number of layers or Z height of the outer wall portion has been completed a second build material is used to form or print an inner portion adjacent to the outer wall portion with a build material such as a foam (also known as a foaming material, solid foam, insulating foam) or other material. The second build material completes the build portion using a layer height thickness that is thicker than the outer wall portion and consists of less layers. The inner portion could be laid down, printed or formed in a single layer filling the entire 3D object. This way, an insulated concrete wall or foam filled object could be quickly produced by a 3d printing machine.

According to a one aspect of the invention a 3D printing apparatus is configured to print a material such as but not limited to concrete or plastic. The apparatus could be used to manufacture an outer wall portion of a printed object, once a set number of layers or Z height of the outer wall portion has been completed a second build material is used to form or print an inner portion using a layer height thickness that is thicker than the outer wall portion and consists of less layers. The second build material could comprise a higher strength build material or a stronger grade of concrete than the first build material. The inner portion could be printed or filled in a single layer to ensure consistent curing of the second build material. The process can be repeated until the object height is completed. This way, a structure able to support a higher load that the first build material alone could be produced on site by one 3d printing machine.

According to a one aspect of the invention a 3D printing apparatus configured to print a material such as a gel or liquid which could contain genetic material the apparatus could be used to manufacture an outer wall portion of a printed object for use as a piece of living tissue such as a human or non human piece, once a set Z height of the outer wall portion has been completed a second print head then introduces by flooding or laying down thick material an inner portion into the outer wall portion. The second build material completes the build portion. The process can be repeated until the object height is completed. This way, a living organ or piece of living tissue could be produced rapidly.

According to a first aspect of the invention a new method of computing the way in which the inner portion material is laid down or produced is provided to allow faster production of 3D objects whilst ensuring that a high definition is maintained when producing the outer wall portion. According to one aspect of the invention a file to be used for 3D printing is prepared for use on a 3D printer that has at least one printing nozzle. The file contains the steps of forming the outer wall portion of the object at a higher definition than the inner portion by creating more outer wall portion layers than inner portion layers. A printing nozzle is used to print several layers of outer wall portion material which are printed, formed or laid down one on top of the next to produce a first height of outer wall portion. Once the first height has been produced the printer begins to form the inner portion of the 3D object using a thicker layer height than when compared to the layer height of the outer wall portion. The printing of the inner portion is produced at a height thickness that is equal to the thickness of first height whilst using less layers of material and completes the build portion. The process can be repeated until the object height is completed. The inner portion could be printed in a single layer filling the entire 3D object.

According to one aspect of the invention, if an outer layer of 0.1 mm for printing the first height and a layer height of 0.4 mm were used for printing the second height then the previously mentioned 10 cm high printed part would be completed using around 100 outer wall portion layers and around 25 inner portion layers. One inner portion layer would be laid down for every four outer wall portion layers. As most of the printing time is consumed by laying down inner portion material the resulting printed part would be completed in a small percentage of the regular print time.

According to a one aspect of the invention a light source could be used to manufacture the outer wall portion of the 3d object. A file is produced which contains the steps of forming the outer wall portion of the object at a higher definition than the inner portion layers. A light source is used to print several layers of outer wall portion material which are printed or laid down one on top of the next to produce a first height of outer wall portion. Once the first height has been printed the printer prints the unseen inner portion or using a thicker layer height to form the unseen inner core or inner portion material. The printing of the inner portion material is produced at a thickness that is equal to the thickness of first height and completes the build portion. The process can be repeated until the object height is completed.

According to a one aspect of the invention multiple print heads are used to form a 3d object. A print head having a smaller nozzle is used to form multiple layers of outer wall portion and then a print head having a larger nozzle is used to form the inner portion in fewer layers. For example a print head having a 0.1 mm nozzle could be used to form the outer wall portion and then a print head having a 1.4 mm nozzle could be used to form the inner portion. The outer wall portion could be printed using 14 0.1 mm layers and then a single layer of 1.4 mm material could be printed for the inner portion. The resulting 3D object would be built in a small percentage of the time it would normally take to form a 3D object using the current state of the art.

The apparatus could have multiple print heads, each configured to form a different build material. The apparatus could have multiple print heads with each configured to form a range of build materials. The apparatus could have multiple print heads with at least one print head configured to form a different thicknesses or width of build materials when compared to another print head.

As previously mentioned, in this application to distance this application from the known art ‘variable layer thickness’ the term adjacent will be used to refer to layers or extruded paths that are adjacent in the X-Y direction and occupy the same Z height or occupy a similar layer distance from the build plate within the printed object. Adjacent will not refer to layers that are formed above or below the layer or layers referred to. The term build portion refers to a section of the 3D object which extends from a fixed height or distance from the build plate to a second height or distance from the build plate. For example on a typical 3D printing apparatus this would be from Z build height 1 mm to Z build height 5 mm. This range of 1 mm to 5 mm is an example and should not be used to limit this application in any way. Some 3D printers also employ a side build direction whereby the part is formed on a vertical build platform (build plate) and layers are build up to form a 3d object in a horizontal direction, in this instance the build height, layer height or distance from the build plate would extend in the direction that the part was being formed layer by layer.

A build portion may consist of 1 or more layers of inner portion material. A build portion will always refer to more than 1 layer of outer wall portion.

1. A 3D printing apparatus for forming a three-dimensional object, wherein the three-dimensional object comprises an outer wall portion formed by a plurality of layers of build material stacked one above the other and an inner portion formed by at least one layer of build material adjacent to the outer wall portion,
wherein the outer wall portion comprises an extruded paste material,
wherein the inner portion comprises foam,
and wherein the apparatus comprises:
at least one print head moveable over a two-dimensional plane for forming
the layers from at least one build material in predefined shapes; and
a control unit for controlling movement of the at least one print head and flow of the at least one building material to the at least one print head,
wherein the control unit is configured to form the at least one layer of the inner portion with an individual layer height thickness greater than a layer height thickness of the individual layers of outer wall portion.

2. The apparatus of claim 1, wherein the inner portion build material comprises an insulating build material.

3. A 3D printing apparatus for forming a three-dimensional object, wherein the three-dimensional object comprises an outer wall portion formed by a plurality of layers of build material stacked one above the other and an inner portion formed by at least one layer of build material adjacent to the outer wall portion,
wherein the outer wall portion comprises an extruded build material,
wherein the inner portion comprises a liquid that can be poured,
and wherein the apparatus comprises,
at least one print head moveable over a two-dimensional plane for forming the layers from the at least one build material in predefined shapes; and
a control unit for controlling movement of the at least one print head and flow of the at least one building material to the at least one print head,
wherein the control unit is configured to form the at least one layer of the inner portion with an individual layer height thickness greater than a layer height thickness of the individual layers of outer wall portion.

4. The apparatus of claim 3, wherein the inner portion build material comprises resin.

5. The apparatus of claim 3, wherein one build material comprises concrete.

6. A 3D printing apparatus for forming a three-dimensional object from a build material, wherein the three-dimensional object comprises an outer wall portion formed by a plurality of layers of build material stacked one above the other and an inner portion formed by at least one layer of build material adjacent to the outer wall portion, and wherein the apparatus comprises:
at least one print head moveable over a two-dimensional plane for forming the layers of build material in predefined shapes; and
a control unit for controlling movement of the at least one print head and flow of the building material to the at least one print head,
wherein the control unit is configured to form the at least one layer of the inner portion with a layer height thickness greater than a layer height thickness of the individual layers of outer wall portion.

7. A system which uses the apparatus of claim 1 wherein the control unit is configured to calculate the path to be followed by the print head to form an outer wall portion comprising a plurality of layers of the at least one build material stacked one above the other up to a predetermined height;
and calculate the path to be followed by the print head in a next step to form an inner portion formed by at least one layer of the at least one build material adjacent to the outer wall portion with a layer height thickness greater than a layer height thickness of the individual layers of outer wall portion

8. The apparatus of claim 6, wherein at least one build material comprises extruded plastic.

9. The apparatus of claim 6, wherein at least one build material comprises extruded paste.

10. The apparatus of claim 6, wherein at least one build material comprises a gel.

11. A system which uses the apparatus of claim 6, wherein at least one build material comprises of a liquid.

12. A system according to claim 6, wherein at least one build material comprises genetic material.

13. The apparatus according to claim 6, wherein at least one build material comprises a curable resin.

14. A method of 3D-printing a three-dimensional object obtainable from the method of claim 6, comprising an outer wall portion by a plurality of layers of the at least one build material stacked one above the other, and forming an inner portion by at least one layer of the at least one build material adjacent to the outer wall portion wherein the at least one layer of the inner portion has a layer thickness greater than a layer height thickness of the individual layers of outer wall portion.

15. A product obtainable from the method of claim 14, wherein a section of the outer wall portion of the product comprises of a first number of individual layers stacked one above the other and the adjacent inner portion comprises of layers with a individual layer height thickness greater than a layer height thickness of the individual layers of outer wall portion.

16. A 3D printed object obtainable from the method of claim 14, wherein a section of the outer wall portion of the product comprises a first number of individual layers stacked one above the other and the adjacent inner portion comprises layers with a individual layer height thickness greater than a layer height thickness of the individual layers of outer wall portion.
